(19) United States
(12) Patent Application Publication
(10) Pub. No.: US 2024/0409675 A1
(43) Pub. Date: Dec. 12, 2024

(54) BIODEGRADABLE COPOLYMERS

(71) Applicant: Wackker Chemie AG, Munich (DE)

(72) Inventors: Benjamin Richard Kordes, Munich (DE); Laura Ascherl, Munich (DE); Timo Melchin, Munich (DE)

(73) Assignee: Wackker Chemie AG, Munich (DE)

(21) Appl. No.: 18/702,347

(22) PCT Filed: Nov. 2, 2021
(86) PCT No.: PCT/EP2021/080413

§ 371 Date: Apr. 18, 2024

(51) Int. Cl. C08F 218/08; C08F 218/10; C08F 220/06; C08F 220/18; C08F 234/02

(52) U.S. Cl. CPC C08F 218/08; C08F 218/10; C08F 220/06; C08F 220/1804; C08F 234/02; C08F 2800/10; C08F 2800/20

(57) ABSTRACT

Biodegradable copolymers obtainable via radically initiated emulsion polymerization processes are provided. The biodegradable copolymers contain one or more monomer units of the formula I,

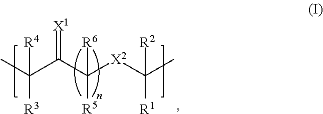

and vinyl acetate units. In formula I, n=1 to 3, X¹ and X² independently of one another are the atoms O or S or the group N—R⁷, R¹ and R² independently of one another are hydrogen, an alkyl, alkenyl, alkoxy or aryl radical or a spirocyclic aliphatic group, and R³, R⁴, R⁵, R⁶ and R⁷ independently of one another are hydrogen or an alkyl or aryl radical.

The invention relates to biodegradable copolymers, to processes for preparing them via radically initiated polymerization, and to their use for example in adhesive bonding materials or coating materials, more particularly in paints or inks, or for producing sheetlike textile structures, or as binders for construction coatings, such as tile adhesives or exterior wall insulation adhesives.

As well as being presently ubiquitous in a wide variety of different everyday products or packaging materials, petrochemical polymers are also a constituent of coating or adhesive bonding materials. Many petrochemical polymers are accessible through radically initiated polymerization of ethylenically unsaturated monomers, such as acrylic esters, vinyl chloride or vinylaromatics. A problem, however, is that conventional petrochemical polymers are generally not biologically degradable and under natural conditions are also not broken down ecologically, and consequently, when disposed of, are highly persistent in the environment, which they contaminate. On ecological grounds, consequently, the ambition exists to modify petrochemical polymers such that the polymers can be degraded as far as possible completely, or at least partially, biologically or, generally, under natural conditions and hence are biodegradable. Here, the modified polymers are as far as possible to match, or at least adequately fulfill, the performance properties of the hitherto established polymers. Moreover, the polymers are to be also accessible through polymerization in aqueous medium or by bulk polymerization processes, to prevent environmental pollution by solvents.

One approach to solving this problem sees the incorporation, into the polymers, of monomers which are labile under natural conditions. Thus, for example, EP3722334, U.S. Pat. No. 5,541,275 and EP3722341 described the polymerization of vinyl acetate and cyclic ketene acetals, specifically 2-methylene-1,3-dioxo-hydrocarbon ring systems, such as 2-methylene-1,3-dioxepane (MDO), in aqueous medium at pH levels of 6 to 9 and 30° C. to 55° C. The lability of such cyclic ketene acetals, however, is such that under the conditions of the aqueous emulsion polymerization itself they tend to hydrolyze and are then no longer polymerizable, as emphasized by U.S. Pat. No. 5,541,275 and EP3722334. C. U. Pittman in Journal of Organic Chemistry, 1995, 60, pages 5729 to 5731, and B. Capon in Journal of American Chemical Society, Vol. 103, No. 7, 1981, pages 1765 to 1768, also report a rapid hydrolysis of 2-methylene-1,3-dioxo-hydrocarbon ring systems, including that of 2-methylene-1,3-dioxolane and, in the case of C. U. Pittman in Journal of Organic Chemistry, 1995, 60, pages 5729 to 5731, explicitly that of 2-methylene-1,3-dioxepane. Consequently, it is difficult even to reproduce such processes, and U.S. Pat. No. 5,541,275 points away from the emulsion polymerization.

W. J. Bailey, in Journal of Polymer Science, Part C, 25, 1987, pages 243-248, describes the homopolymerization of 2-phenyl-4-methylene-1,3-dioxolane by bulk and solution polymerization processes and studies various reaction mechanisms, such as polymerization by way of the vinyl group of the monomer with retention of the 1,3-dioxolane ring (vinyl polymerization), polymerization with elimination of benzaldehyde, or polymerization with ring opening. Journal of Photochemistry and Photobiology A, 109, 1997, pages 185 to 193 also discusses the vinyl polymerization, the ring-opening polymerization and the elimination polymerization of different 4-methylene-1,3-dioxolanes and describes the preparation of polyketone homopolymers via cationic photopolymerization. M. Goodman, Journal of Polymer Science, Part A, Vol. 2, 1964, pages 3471 to 3490, employs IR spectra to study the cationically catalyzed copolymerization of acrylonitrile with, respectively, 4-methylene-2,2-dimethyl-1,3-dioxolane, 4-methylene-2-methyl-1,3-dioxolane and 4-methylene-1,3-dioxolane at temperatures in the region of 35° C. and −78° C. There is discussion here of vinyl polymerization and ring-opening polymerization mechanisms. Y. Nakashima, Journal of Polymer Science, Polymer Chemistry Edition, Volume 20, 1982, pages 1401 to 1409, describes the solution and bulk polymerization of 4-methylene-1,3-dioxolane or 4-methylene-2,2-dimethyl-1,3-dioxolane with maleic anhydride or dimethyl maleate and optionally acrylonitrile by vinyl polymerization processes without addition of initiator, with retention of the dioxolane ring. Here, however, only small amounts of the acrylonitrile used were copolymerized. DE906514 as well relates to the polymerization of cyclic vinyl ethers with cationic catalysts by way of ion chain reactions. Conversely, these publications do not discuss radically initiated emulsion polymerization and the degradability of the polymers.

Labile monomers are by nature unstable, in many cases even under polymerization conditions, and tend toward side reactions or degradation reactions; it therefore poses a challenge to copolymerize the labile monomers into the polymers in a targeted and as far as possible complete manner. Such monomers may also have disadvantageous copolymerization properties, meaning that no copolymers are formed. Moreover, unsaturated heterocycles in particular may have low polymerization rates, necessitating long polymerization times and addition of relatively substantial amounts of initiator, which is economically disadvantageous and, moreover, leads to polymers of low molecular mass, as set out in the aforementioned U.S. Pat. No. 5,541,275.

Against this background, the object was to modify conventional petrochemical polymers such that one or more of the problems discussed above are solved or alleviated.

A subject of the invention are biodegradable copolymers containing
a) one or more monomer units of the formula I:

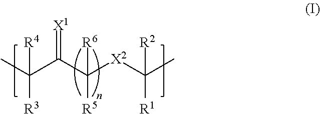

where n=1 to 3,
in which X¹ and X² independently of one another are the atoms O or S or the group N—R⁷,
R¹ and R² independently of one another are hydrogen, an alkyl, alkenyl, alkoxy or aryl radical or a spirocyclic aliphatic group,
R³, R⁴, R⁵, R⁶ and R⁷ independently of one another are hydrogen or an alkyl or aryl radical, and
b) one or more monomer units selected from the group encompassing vinyl ester, (meth)-acrylic ester, vinylaromatic, olefin, 1,3-diene and vinyl halide units.

A further subject of the invention are processes for preparing biodegradable copolymers by radically initiated polymerization of
a) one or more monomers of the formula II:

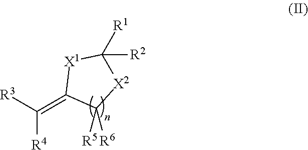

where n=1 to 3,
in which X¹ and X² independently of one another are the atoms O, N—R⁷ or S,
R¹ and R² independently of one another are hydrogen, an alkyl, alkenyl, alkoxy or aryl radical or a spirocyclic aliphatic group,
R³, R⁴, R⁵, R⁶ and R⁷ independently of one another are hydrogen or an alkyl or aryl radical, and
b) one or more ethylenically unsaturated monomers selected from the group encompassing vinyl esters, (meth)acrylic esters, vinylaromatics, olefins, 1,3-dienes and vinyl halides.

The term “biodegradable copolymers” means generally that the copolymers are wholly or partially or fractionally degradable biologically, i.e., on exposure to microorganisms, or, generally, under natural conditions, more particularly on exposure to acidic media, having more particularly a better degradability than corresponding polymers which contain monomer units b) but no monomer units a).

The monomer units a) of the formula I result generally from ring-opening polymerization of the monomers a) of the formula II. The monomer units a) of the formula I are preferably monomer units which contain an ether group and additionally carry a keto group.

In the monomer units a) of the formula I or in the monomers a) of the formula II, n is preferably 1 or 2, more particularly 1.

X¹ and X² are preferably the atoms O or S, more preferably the atom O. Most preferably, X¹ and X² are the atom O.

R¹ and R² independently of one another are preferably hydrogen, a C₁-C₁₂ alkyl, C₂-C₁₂ alkenyl or C₁-C₁₂ alkoxy or an optionally substituted C₆-C₁₂ aryl radical. More preferably, R¹ and R² independently of one another are preferably hydrogen or a C₁-C₁₂ alkyl or a C₁-C₁₂ alkoxy radical.

Preferred alkyl radicals have 1 to 8 carbon atoms, more particularly 1 to 5 carbon atoms.

Preferred alkyl radicals are ethyl, propyl, butyl and more particularly methyl and isopropyl radicals.

Preferred alkoxy radicals have 1 to 8 carbon atoms, more particularly 1 to 5 carbon atoms.

Preferred alkoxy radicals are ethoxy, butoxy and more particularly methoxy radicals.

Preferred alkenyl radicals have 2 to 8 carbon atoms, more particularly 2 to 5 carbon atoms.

Preferred alkenyl radicals are ethylene and propylene radicals.

An example of an aryl radical is a phenyl radical, which may be substituted or unsubstituted.

Examples of spirocyclic aliphatic groups as radicals R¹ and R² are substituted or unsubstituted cyclohexane or cyclopentane radicals.

At least one of the radicals R¹ and R² is preferably other than hydrogen. More preferably, exactly one of the radicals R¹ and R² is other than hydrogen. Most preferably, one of the radicals R¹ and R² is a hydrogen atom and the other of the radicals R¹ and R² is an alkoxy radical and more particularly is an alkyl radical.

R³, R⁴, R⁵, R⁶ and R⁷ independently of one another are hydrogen, a C₁-C₁₂ alkyl or an optionally substituted C₆-C₁₂ aryl radical. The alkyl radicals and alkyl radicals here preferably adopt the meanings stated above for R¹ and R².

More preferably, at least one of the radicals R³ and R⁴ is a hydrogen atom; most preferably, both of the radicals R³ and R⁴ are a hydrogen atom.

More preferably, at least one of the radicals R⁵ and R⁶ is a hydrogen atom; most preferably, both of the radicals R⁵ and R⁶ are a hydrogen atom.

R⁷ is preferably hydrogen or a methyl, phenyl or benzyl radical.

The fraction of the monomer units a) of the formula I or of the monomers a) of the formula II is preferably 1% to 99% by weight, more preferably 2% to 70% by weight, more preferably still 3% to 60% by weight, very preferably 4% to 50% by weight, especially preferably 5% to 40% by weight, most preferably 7% to 30% by weight and the most preferably of all 10% to 20% by weight, each based on the total weight of the biodegradable copolymers.

The monomers a) of the formula II are generally accessible by known processes, as described for example in Journal of Polymer Science, Part C, 25, 1987, pages 243-248 or in Journal of Organic Chemistry, 43, 14, 1978, pages 2773 to 2776.

For example, monomers a) of the formula II may be synthesized by first reacting halogen-substituted diols, more particularly 1,2-diols, with aldehydes or ketones to give cyclic acetals or ketals, preferably with acid catalysis, catalyzed for example by para-toluenesulfonic acid, and thereafter eliminating hydrogen halide. An example of a halogen-substituted 1,2-diol is 3-chloro-1,2-propanediol; a suitable aldehyde is for example isobutylaldehyde. The hydrogen halide may be eliminated conventionally for example by means of an organic or inorganic base, such as potassium hydroxide, triethylamine or 1,8-diazabicyclo [5.4.0] undec-7-ene (DBU). Auxiliaries may also be added, such as emulsifiers or phase transfer catalysts—for example, polyethylene glycol or 2-methylbutan-2-ol. The monomers a) of the formula II may be prepared here in customary solvents—for example, in hydrocarbons, such as cyclohexane or toluene. The monomers a) of the formula II may be isolated and purified in a conventional manner—for example, by fractional vacuum distillation.

The fraction of the monomer units b) or of the monomers b) is preferably 1% to 99% by weight, more preferably 30% to 98% by weight, more preferably still 40% to 97% by weight, very preferably 50% to 96%, especially preferably 60% to 95% by weight, most preferably 70% to 93% by weight and most preferably of all 80% to 90% by weight, each based on the total weight of the biodegradable copolymers.

The following statements relating to monomers b) and monomer mixtures b) refer, analogously, to the monomer units b).

The ethylenically unsaturated monomers b) are preferably selected from the group encompassing vinyl esters of carboxylic acids having 1 to 15 carbon atoms, methacrylic esters or acrylic esters of carboxylic acids with unbranched or branched alcohols having 1 to 15 carbon atoms, olefins or dienes, vinylaromatics or vinyl halides.

Preferred vinyl esters are vinyl acetate, vinyl propionate, vinyl butyrate, vinyl 2-ethylhexanoate, vinyl laurate, 1-methylvinyl acetate, vinyl pivalate and vinyl esters of alpha-branched monocarboxylic acids having 5 to 13 carbon atoms, for example VeoVa9R or VeoVa10R (trade names of Hexion). More preferred is vinyl acetate.

Preferred methacrylic esters or acrylic esters are esters of unbranched or branched alcohols having 1 to 15 carbon atoms such as methyl acrylate, methyl methacrylate, ethyl acrylate, ethyl methacrylate, propyl acrylate, propyl methacrylate, n-butyl acrylate, n-butyl methacrylate, 2-ethylhexyl acrylate and norbornyl acrylate. More preferred are methyl acrylate, methyl methacrylate, n-butyl acrylate, n-butyl methacrylate and 2-ethylhexyl acrylate.

Preferred olefins or dienes are ethylene, propylene and 1,3-butadiene. Preferred vinylaromatics are styrene and vinyltoluene. A preferred vinyl halide is vinyl chloride.

The biodegradable copolymers may optionally contain one or more auxiliary monomer units. The following statements relating to auxiliary monomers refer, analogously, to auxiliary monomer units. There may optionally be an extra 0% to 20% by weight, preferably 1% to 10% by weight, based on the total weight of the biodegradable copolymers, of one or more auxiliary monomers copolymerized. Examples of auxiliary monomers are ethylenically unsaturated monocarboxylic and dicarboxylic acids, preferably acrylic acid, methacrylic acid and fumaric acid; ethylenically unsaturated carboxamides, preferably acrylamide; monoesters and diesters of fumaric acid such as the diethyl and diisopropyl esters, ethylenically unsaturated sulfonic acids and their salts, preferably vinylsulfonic acid and 2-acrylamido-2-methylpropanesulfonic acid. Further examples are precrosslinking comonomers such as polyethylenically unsaturated comonomers, for example divinyl adipate, diallyl maleate, allyl methacrylate oder triallyl cyanurate, or postcrosslinking comonomers, for example acrylamidoglycolic acid (AGA), methylacrylamidoglycolic acid methyl ester (MAGME), N-methylolacrylamide (NMA), N-methylolmethacrylamide (NMMA), N-methylolallylcarbamate, alkyl ethers such as the isobutoxy ether or esters of N-methylolacrylamide, of N-methylolmethacrylamide and of N-methylolallylcarbamate. Also suitable are epoxy-functional comonomers such as glycidyl methacrylate and glycidyl acrylate. Further examples are silicon-functional comonomers, such as acryloxypropyltri (alkoxy)- and methacryloxypropyltri (alkoxy)-silanes, vinyltrialkoxysilanes and vinylmethyldialkoxysilanes, where the alkoxy groups they contain may be, for example, methoxy, ethoxy and ethoxypropylene glycol ether radicals. Further instances include monomers having hydroxyl or CO groups, for example hydroxyalkyl esters of acrylic and methacrylic acids, such as hydroxyethyl, hydroxypropyl or hydroxybutyl acrylate or methacrylate, and compounds such as diacetoneacrylamide and acetylacetoxyethyl acrylate or methacrylate. Further examples are vinyl ethers too, such as methyl, ethyl or isobutyl vinyl ether.

There is preferably no copolymerization of ethylenically unsaturated carbonitriles, more particularly of acrylonitrile. There is preferably no copolymerization of monoesters and diesters of maleic acid, such as the diethyl and diisopropyl esters, and of maleic anhydride. The biodegradable copolymers preferably contain no monomer unit of ethylenically unsaturated carbonitriles, more particularly no acrylonitrile unit. The biodegradable copolymers preferably contain no monomer unit of monoesters and diesters of maleic acid, such as the diethyl and diisopropyl esters, and no maleic anhydride unit.

Preferred monomers b) are vinyl esters, more particularly vinyl acetate, and methacrylic esters or acrylic esters. Particularly preferred also is the use of two or more monomers b) (monomer mixture b)).

Examples of monomer mixtures b) are vinyl acetate with ethylene, monomer mixtures b) of vinyl acetate with ethylene and one or more further vinyl esters, monomer mixtures b) of vinyl acetate with ethylene and acrylic esters, monomer mixtures b) of vinyl acetate with ethylene and vinyl chloride, monomer mixtures b) of styrene and (meth)acrylic esters, and monomer mixtures b) of styrene with 1,3-butadiene.

Preferred are monomer mixtures b) of vinyl acetate with 1% to 40% by weight of ethylene; monomer mixtures b) of vinyl acetate with 1% to 40% by weight of ethylene and 1% to 50% by weight of one or more further comonomers from the group of vinyl esters having 1 to 12 carbon atoms in the carboxylic acid radical, such as vinyl propionate, vinyl laurate, vinyl esters of alpha-branched carboxylic acids having 5 to 13 carbon atoms, such as VeoVa9R, VeoVa10R, VeoVa11R; monomer mixtures b) of vinyl acetate, 1% to 40% by weight of ethylene and preferably 1% to 60% by weight of (meth)acrylic esters of unbranched or branched alcohols having 1 to 15 carbon atoms, more particularly n-butyl acrylate or 2-ethylhexyl acrylate; and monomer mixtures b) with 30% to 75% by weight of vinyl acetate, 1% to 30% by weight of vinyl laurate or vinyl esters of an alpha-branched carboxylic acid having 5 to 13 carbon atoms, and 1% to 30% by weight of (meth)acrylic esters of unbranched or branched alcohols having 1 to 15 carbon atoms, more particularly n-butyl acrylate or 2-ethylhexyl acrylate, which may additionally contain 1% to 40% by weight of ethylene; monomer mixtures b) with vinyl acetate, 1% to 40% by weight of ethylene and 1% to 60% by weight of vinyl chloride; where the monomer mixtures b) may in each case additionally contain the stated auxiliary monomers, preferably in the stated amounts, and the figures in % by weight add up to 100% by weight in each case, based on the total weight of the monomer mixtures b).

Preferred also are monomer mixtures b) of methyl methacrylate with n-butyl acrylate and/or 2-ethylhexyl acrylate and optionally ethylene; monomer mixtures b) of styrene and one or more monomers from the group of methyl acrylate, ethyl acrylate, propyl acrylate, n-butyl acrylate, 2-ethylhexyl acrylate; monomer mixtures b) of vinyl acetate with one or more monomers from the group of methyl acrylate, ethyl acrylate, propyl acrylate, n-butyl acrylate, 2-ethylhexyl acrylate and optionally ethylene; monomer mixtures b) of styrene with 1, 3-butadiene; where the monomer mixtures b) may additionally contain the stated auxiliary monomers, preferably in the stated amounts, and the figures in % by weight add up to 100% by weight in each case, based on the total weight of the monomer mixtures b).

Aqueous dispersions of the biodegradable copolymers have viscosities of preferably 1 to 5000 mPas, more preferably 2 to 1000 mPas, more preferably still 3 to 100 mPas and most preferably 4 to 10 mPas (determined, for example, using a cone/plate rheometer from Anton Paar, model MCR 302 with a cone pitch of 1° and a plate diameter of 25 mm, at 25.0° C. and 20 rpm for dispersions having a solids content of 25%. Evaluation may take place using, for example, the RheoPlus software, version 3.62).

The biodegradable copolymers have number-average molecular weights of preferably 500 to 2 000 000 g/mol, more preferably 1000 to 200 000 g/mol, very preferably 3000 to 50 000 g/mol, especially preferably 4000 to 30 000 g/mol and most preferably 5000 to 20 000 g/mol (determination via gel permeation chromatography with THE as solvent, with polystyrene as standard, preferably on a PLgel MiniMIX-C guard column at a column temperature of 35° C.; calibration takes place, for example, polynomially with correction by internal standard; the detector used is preferably a refractive index detector of the 1260 model series from Agilent. The sample volume used generally comprises 20 μL of sample solution with a sample concentration of 4 mg/mL).

The particle size of the biodegradable copolymers is preferably from 50 to 7000 nm, more preferably 75 to 1000 nm and most preferably 100 to 300 nm (determined via dynamic light scattering on a Zetasizer Nano-S instrument from the manufacturer Malvern Instruments GmbH at 20.0° C. against a polyvinyl acetate standard and water as dispersion medium. Each determination is typically carried out in triplicate; each measurement generally contains 10 measuring intervals. Evaluation takes place using, for example, the Zetasizer software, version 8.01.4906).

The biodegradable copolymers are preferably also stable at elevated temperatures, more preferably also at temperatures of 130 to 260° C. The temperature at which decomposition begins may be determined, for example, via thermogravimetric analysis (TGA). The TGA investigation is carried out on a TGA 2 instrument from Mettler Toledo. Selected for example are a heating program from 20 to 800° C., a heating rate of 10° C./min and nitrogen as measuring gas. The instrument can be calibrated using, for example, the test media Trafoperm, Isatherm and nickel. Evaluation takes place using, for example, the STARe software, version 16.10.

The monomer units a) and the monomer units b) are preferably copolymerized randomly into the biodegradable copolymers.

The monomers a) and b) may be polymerized for example by processes of solution polymerization, suspension polymerization, microsuspension polymerization, miniemulsion polymerization or, preferably, of bulk polymerization or, in particular, emulsion polymerization. In this context, process conditions known per se can be used.

The polymerization is implemented preferably at pH values between 3 and 9, more preferably between 4 and 7 and most preferably between 4.5 and 6. The pH may be adjusted in a known manner by organic or inorganic acids, bases or buffers, such as, for example, by addition of alkali metal or alkaline earth metal (hydrogen) carbonates, ammonia, amines or alkali metal hydroxides, such as sodium hydroxide, for example.

The polymerization temperature is generally 20° C. to 120° C., preferably 30° C. to 100° C., most preferably 50° C. to 80° C.

For the copolymerization of gaseous comonomers, such as ethylene, polymerization is performed preferably under pressure, generally at between 5 bar and 100 bar.

The polymerization may be initiated with customary water-soluble or monomer-soluble or oil-soluble initiators or redox initiator combinations. Examples of oil-soluble initiators are oil-soluble peroxides, such as t-butyl peroxy-2-ethylhexanoate, t-butyl peroxypivalate, t-butyl peroxyneodecanoate, dibenzoyl peroxide, t-amyl peroxypivalate, di(2-ethylhexyl) peroxydicarbonate, 1,1-bis(t-butylperoxy)-3,3,5-trimethylcyclohexane, di(4-t-butylcyclohexyl) peroxydicarbonate, dilauroyl peroxide, cumyl hydroperoxide, or oil-soluble azo initiators, such as azobisisobutyronitrile or dimethyl 2,2′-azobis(2-methylpropionate). Examples of water-soluble initiators are peroxodisulfates, such as potassium peroxodisulfate, hydrogen peroxide, water-soluble hydroperoxides such as tert-butyl hydroperoxide, manganese (III) salts or cerium (IV) salts. The initiators are used in general in an amount of 0.005% to 3.0% by weight, preferably 0.01% to 1.5% by weight, based in each case on the total weight of the ethylenically unsaturated monomers. Using redox initiators is preferred. Redox initiators used comprise combinations of the stated initiators in combination with reducing agents. Examples of suitable reducing agents are sodium sulfite, iron (II) salts, sodium hydroxymethanesulfinate and ascorbic acid. Preferred redox initiators are cerium (IV) salts, such as ammonium cerium (IV) nitrate, manganese (III) salts or peroxodisulfates, and combinations of these initiators. Where reducing agents are used, the amount of reducing agent is preferably 0.01% to 0.5% by weight, based on the total weight of the ethylenically unsaturated monomers.

To control the molecular weight, common chain transfer substances may be added during the polymerization. If chain transfer agents are used, the amounts thereof employed typically are between 0.01% to 5.0% by weight, based on the monomers to be polymerized. Chain transfer agents are metered preferably separately or else as a premix with reaction components.

Examples of chain transfer agents are n-dodecyl mercaptan, tert-dodecyl mercaptan, mercaptopropionic acid, methyl mercaptopropionate, isopropanol and acetaldehyde.

The monomers may be included entirely or, preferably, partially in the initial charge, and any remaining amount of monomers may be metered in during the polymerization. Any emulsifiers and any protective colloids may be included entirely or, preferably, partially in the initial charge, and the remaining amount, where appropriate, of emulsifiers and/or protective colloids may be metered in during the polymerization.

The bulk polymerization takes place generally without addition of solvents, i.e., in the absence of solvents—that is, in bulk.

The solution polymerization takes place preferably in one or more nonaqueous solvents, such as alcohols, esters, ethers or ketones, for example. The organic solvents contain preferably 1 to 12 carbon atoms and more preferably 1 to 8 carbon atoms. Examples of alcohols are methanol, ethanol, propanol, butanol and benzyl alcohol. Examples of ethers are dioxane, tetrahydrofuran, diethyl ether, diisopropyl ether and diethylene glycol dimethyl ether. Examples of esters are ethyl acetate, butyl acetate, propyl propionate, ethyl butyrate and ethyl isobutyrate. Particularly preferred solvents are ethanol, ethyl acetate and acetone.

The suspension polymerization and the emulsion polymerization take place in general in aqueous medium.

Suspension polymerization processes and emulsion polymerization processes may take place in the presence of protective colloids and/or emulsifiers. It is, though, also possible to polymerize in the absence of protective colloids and emulsifiers.

Suitable emulsifiers are, in particular, anionic surfactants and nonionic surfactants. Examples of anionic surfactants are alkyl sulfates having a chain length of 8 to 18 carbon atoms, alkyl and alkylaryl ether sulfates having 8 to 18 carbon atoms in the hydrophobic radical and up to 40 ethylene oxide or propylene oxide units, alkyl- or alkylarylsulfonates having 8 to 18 carbon atoms, oleic acid sulfonates, esters and monoesters of sulfosuccinic acid with monohydric alcohols or alkylphenols. Suitable nonionic surfactants are, for example, alkyl polyglycol ethers or alkylaryl polyglycol ethers having 8 to 40 ethylene oxide units. Preferred for use are alkyl ether sulfates or dodecylbenzenesulfonates.

Preference is given to using up to 6% by weight, more preferably 0.1% up to 5% by weight and most preferably 1% to 4% by weight of one or more emulsifiers, based on the total weight of the monomers employed overall.

Examples of protective colloids are polyvinyl alcohols; polyvinylpyrrolidones; polyvinyl acetals; polysaccharides; synthetic polymers such as poly(meth)acrylic acid, copolymers of (meth)acrylates with carboxyl-functional comonomer units, poly(meth)acrylamide, polyvinylsulfonic acids and water-soluble copolymers thereof; styrene-maleic acid and vinyl ether-maleic acid copolymers. Preferred protective colloids are polyvinyl alcohols, especially partly hydrolyzed or fully hydrolyzed polyvinyl alcohols having a degree of hydrolysis of 80 to 100 mol %. More preferred are partly hydrolyzed polyvinyl alcohols having a degree of hydrolysis of 80 to 95 mol %, and more particularly having a Höppler viscosity, in 4% aqueous solution, of 1 to 30 mPas (Höppler method at 20° C., DIN 53015).

After the end of the polymerization, residual monomers may be removed by employing known techniques of postpolymerization—for example, by postpolymerization initiated with redox catalyst. Volatile residual monomers may also be removed via distillation, preferably under reduced pressure, and optionally with inert entraining gases such as air, nitrogen or steam being passed through or over the polymerization product.

The biodegradable copolymers are preferably present in the form of solid resins, in the form of aqueous dispersions, or in the form of water-redispersible powders. More preferably, the biodegradable copolymers are present in the form of protective colloid-stabilized and/or emulsifier-stabilized aqueous dispersions or in the form of protective colloid-stabilized and/or emulsifier-stabilized water-redispersible powders.

Solid resins may be isolated from an aqueous dispersion or a nonaqueous solution via customary methods—for example, by precipitation, filtration and subsequent drying, or via decanting and subsequent drying. The drying may take place in a manner known to the skilled person, for example, in a drum dryer, in a flow tube, in a fluidized bed, or in a cyclone dryer.

The biodegradable copolymers in the form of aqueous dispersions have a solids content of preferably 20% to 80%, more preferably of 30% to 70% and most preferably of 40% to 60% (determined with the MA 20 Moisture Analyzer from Sartorius, with drying of the sample to constant weight at 120° C.). Biodegradable copolymers in the form of aqueous dispersions are obtained, for example, in the case of aqueous suspension or emulsion polymerization.

The water-redispersible polymer powders are generally produced by drying the aqueous polymer dispersions, optionally after addition of protective colloids as a drying aid, by means, for example, of fluidized bed drying, freeze drying or spray drying. The dispersions are preferably spray-dried. This spray drying may be carried out in customary spray-drying units, where the atomization may take place by means of single-fluid, two-fluid or multifluid nozzles or with a rotating disk. The exit temperature selected is generally in the range from 45° C. to 120° C., preferably 60° C. to 90° C., depending on unit, copolymer Tg and desired degree of drying. Examples of drying aids are the abovementioned protective colloids, especially polyvinyl alcohol. Generally speaking, the drying aid (protective colloid) is used in a total amount of 3% to 30% by weight, more particularly 5% to 20% by weight, based on the polymeric constituents of the dispersion.

In the case of the atomizing for drying aqueous polymer dispersions, the presence of up to 3% by weight of antifoamer, based on the base polymer, has proven in many cases to be favorable. To increase the shelf life by improving the blocking stability, the polymer powder obtained may be furnished with an antiblocking agent (anticaking agent), preferably up to 30% by weight, based on the total weight of polymeric constituents. Examples of antiblocking agents are Ca and/or Mg carbonate, talc, gypsum, silica, kaolins, metakaolin, calcined kaolin, and silicates, having particle sizes preferably in the range from 10 nm to 100 μm.

The viscosity of the mixture to be dried is adjusted by way of the solids content so as to give a value of preferably <1500 mPas, more preferably <500 mPas (viscosity at 20 revolutions and 25.0° C.). The solids content of the mixture to be dried is preferably >35%, more preferably >40%.

To improve the performance properties, further adjuvants may be added during drying. Further constituents of dispersion powder compositions, present in preferred embodiments, are pigments, fillers, foam stabilizers, hydrophobizing agents or cement plasticizers, for example.

The biodegradable copolymers are suitable generally as binders for coating materials or adhesive bonding materials, more particularly for paints, inks, fibers, textiles, leather, paper or carpets. Also preferred is the use of the biodegradable copolymers as binders for the binding of fiber materials, especially for the production of sheetlike textile structures, such as nonwovens, knitted and woven goods, leather and furs, or carpets, or as binders for construction coatings, especially for aqueous emulsion paints or powder paints.

Further, the biodegradable copolymers are also suitable for use in construction chemical products. They may be used alone or in combination with conventional polymer dispersions or dispersion powders, optionally in conjunction with hydraulically setting binders such as cements (Portland cement, high-alumina cement, trass cement, blast furnace cement, magnesia cement, phosphate cement), gypsum and waterglass, for the production, for example, of leveling compounds, construction adhesives, renders, filling compounds, jointing mortars, grouts, exterior wall insulation systems, paints or inks, examples being powder paints. Within construction adhesives, preferred fields of use are as tile adhesives or thermal insulation composite system adhesives. Preferred areas of application extend to leveling compounds; preferred leveling compounds are self-leveling floor-filling compounds and screeds.

Further, biodegradable copolymers containing vinyl esters, especially vinyl acetate, as monomers b) can be converted into polyvinyl alcohols by hydrolysis. Such polyvinyl alcohols may be used, for example, as protective colloids for the emulsion or suspension polymerization of ethylenically unsaturated monomers or else as a drying aid in the drying of aqueous polymer dispersions.

Advantageously, the copolymers of the invention are degradable very effectively and to a great extent, biologically or under natural conditions.

Surprisingly, the monomers of the invention are copolymerizable in virtually any proportions. The monomers a) and b) have advantageous copolymerization characteristics, meaning that there is no need for long polymerization times or for relatively substantial amounts of initiator and that even copolymers of relatively high molecular weight are obtainable. In this context, the monomers a) of the invention undergo incorporation into the copolymers very selectively with ring opening, to form the monomer units a) of the formula I of the invention. Side reactions, such as vinyl polymerization or polymerization with elimination, for example, of aldehydes or ketones, occur preferably not to any significant extent. Moreover, the monomers a) of the invention have advantageous stability under polymerization conditions, and so hydrolysis does not occur, not even, in particular, in the case of polymerization in aqueous medium, even at the pH values common for emulsion polymerization, and even without protective gas techniques, in contrast to other monomers which are copolymerizable with ring opening, such as the cyclic ketene acetal 2-methylene-1,3-dioxepane (MDO).

The examples which follow serve for further elucidation of the invention:

Determining the monomer composition of the biodegradable copolymers:

The fraction of the monomer units a) of the formula I in the biodegradable copolymers was determined via 1H NMR spectroscopy. For this purpose, integrals of characteristic signals of the monomer units were evaluated, such as, for example, the integral of the methyl groups of 2-isopropyl-4-methylene-1,3-dioxolane (0.95 to 0.75 ppm (6H, m)) or the integral of one of the vinyl acetate groups (5.30 to 4.70 ppm (1H, m)).

The 1H NMR spectra were recorded, for example, in deuterated chloroform with the Bruker Ascend 500 MHz instrument, with the Advance III HD console and with the BBO sample head.

Typically, 75% to 99% of the monomers a) of the formula II used were copolymerized into the biodegradable copolymers.

### Synthesis of Monomers a) of the Formula II: Synthesis of 4-(chloromethyl)-2-isopropyl-1,3-dioxolane via acetalization

3-Chloro-1,2-propanediol (20 g; 181 mmol), isobutylaldehyde (13.05 g; 181 mmol), para-toluenesulfonic acid (200 mg) and 50 mL of toluene were charged to a round-bottom flask. At 140° C., water was removed for 1 h. The product was purified by fractional vacuum distillation. Yield: 26.6 g, 161.6 mmol; 89.3% of theoretical yield.

### Synthesis of 2-isopropyl-4-methylene-1,3-dioxolane (14MDO) via elimination

Polyethylene glycol-500 (PEG-500) (7.22 g; 14.4 mmol), 2-methylbutan-2-ol (7.22 g; 81.8 mmol) and 400 mL of cyclohexane were initially introduced. Thereafter, with stirring, potassium hydroxide (KOH) (160.2 g; 2.86 mol) was added. The mixture was heated to 80° C. Subsequently, over a period of 60 min, 4-(chloromethyl)-2-isopropyl-1,3-dioxolane (132.2 g; 808 mmol) was added from a dropping funnel. The mixture was subsequently stirred at 80° C. for 5 hours. A yellowish mass of potassium hydroxide (KOH) and potassium chloride (KCl) was removed by filtration. This was followed by fractional distillation.

Yield: 58.6 g, 457 mmol; 56.6% of theoretical yield.

### Synthesis of 4-(chloromethyl)-2-methoxy-1,3-dioxolane via transacetalization

Trimethoxymethane (317.1 g; 2.99 mol), 3-chloro-1,2-propanediol (277.0 g; 2.51 mol) and concentrated sulfuric acid (0.7 g) were heated in a 1000 mL flask in a distillation apparatus for 3 hours at 100° C. Subsequently, 3 spatula tips of sodium hydrogencarbonate (NaHCO₃) were added and the mixture was subjected to fractional vacuum distillation.

Yield: 355.0 g; 2.33 mol=93.0% of theoretical yield, based on 3-chloro-1,3-propanediol.

### Synthesis of 4-methylene-2-methoxy-1,3-dioxolane (MOMDO) via elimination

400 mL of cyclohexane were admixed with PEG-2000 (19.3 g; 9.7 mmol) and 2-methylbutan-2-ol (27.4 g; 311 mmol). With stirring, potassium hydroxide (KOH) (182.8 g; 3.26 mol) was added. The mixture was heated to 80° C. With stirring, 4-(chloromethyl)-2-methoxy-1,3-dioxolane (140.6 g, 921 mmol) was added dropwise. The mixture was stirred for 16 hours at 80° C. using a core precision-ground stirrer.

Subsequently, using a pressurized suction filter, the solid residue was isolated by filtration, washed with cyclohexane and purified via fractional vacuum distillation.

Yield: 59.7 g; 514 mmol=55.8% of theory.

Polymerization with Monomers a) of the Formula II:

### EXAMPLE 1

### Aqueous emulsion polymerization of vinyl acetate with 2-isopropyl-4-methylene-1,3-dioxolane (14MDO)

A 1 L reactor (CSTR), purged with argon, equipped with water-operated, thermostat-controlled heating jacket and core precision-ground stirring attachment (stirring speed: 235 revolutions per minute) and with a reflux condenser, was charged with deionized water (250 mL), sodium dodecyl sulfate (4.2 g) and sodium hydrogencarbonate (2.1 g). When the temperature reached 71° C., the following phases were added, separately from one another but simultaneously:
a) monomer phase, consisting of vinyl acetate (140 g) and 2-isopropyl-4-methylene-1,3-dioxolane (10.5 g), dropwise addition rate 1.3 mL/min;
b) initiator phase, consisting of water (84 mL) with ammonium peroxodisulfate (2.81 g) dissolved therein; at the start of dropwise addition, first one milliliter of the solution was added all at once, after which the dropwise addition rate was set as follows: 0.35 mL/min in the first half an hour, later 0.5 mL/min until the end of the addition;
c) aqueous phase, consisting of water (42 mL) and sodium 2-acrylamido-2-methylpropanesulfonate (3.51 g), dropwise addition rate 0.35 mL/min in the first half an hour, later 0.5 mL/min until the end of the addition.

After 2 hours, 0.5 mL of a 70% aqueous tert-butyl hydroperoxide solution were added all at once for post-polymerization. After a further hour, the reaction was ended.

A pH of 5.0 was established.

The solids content of the emulsion was 25.90%.

The incorporation ratio of the copolymerized 2-isopropyl-4-methylene-1,3-dioxolane to vinyl acetate was 3.7 mol % (corresponding to 77% of the maximum anticipated value).

The particle size was 79 nm, the particle size distribution a PDI of 0.134. The number-average molecular weight of the polymer dispersion was 17.2 kg/mol, the PDI 3.79. The viscosity was 5.1 mPas at 25° C. and 20 revolutions per minute.

A stable, pale yellow emulsion was obtained.

### EXAMPLE 2

### Aqueous emulsion polymerization of n-butyl methacrylate with 2-isopropyl-4-methylene-1,3-dioxolane (I4MDO)

A 1 L reactor (CSTR), purged with argon, equipped with water-operated, thermostat-controlled heating jacket and core precision-ground stirring attachment (stirring speed: 235 revolutions per minute) and with a reflux condenser, was charged with deionized water (250 mL), sodium dodecyl sulfate (4.19 g) and sodium hydrogencarbonate (2.2 g). When the temperature reached 85° C., the following phases were added, separately from one another but simultaneously:
a) monomer phase, consisting of n-butyl methacrylate (140 g) and 2-isopropyl-4-methylene-1,3-dioxolane (28 g), dropwise addition rate 1.2 mL/min;
b) initiator phase, consisting of water (84 mL) with ammonium peroxodisulfate (2.1 g) dissolved therein; the first milliliter of the solution was added all at once, after which the dropwise addition rate was set to 0.35 mL/min;
c) aqueous phase, consisting of water (42 mL) and sodium 2-acrylamido-2-methylpropanesulfonate (3.5 g), dropwise addition rate 0.35 mL/min.

After 2 hours and 15 minutes, the addition of monomer was at an end.

A pH of 8.0 was established. The reaction was continued for 1 hour and 10 minutes at 85° C., still with stirring.

The solids content of the emulsion was 30.87%.

The incorporation ratio of the copolymerized 2-isopropyl-4-methylene-1,3-dioxolane to n-butyl methacrylate was 15.4 mol % (corresponding to 93% of the maximum anticipated value). The particle size was 58 nm, the particle size distribution a PDI of 0.090. The number-average molecular weight of the polymer dispersion was 25.0 kg/mol, the PDI 3.92. The viscosity was 5.3 mPas at 25° C. and 20 revolutions per minute.

A stable, colorless emulsion was obtained.

### EXAMPLE 3

### Mini-co-emulsion polymerization of 2-methoxy-4-methylene-1,3-dioxolane (MOMDO) with vinyl laurate

Water (120 mL), azobis(isobutyronitrile) (AIBN) (0.5 g), 2-methoxy-4-methylene-1,3-dioxolane (5.0 g), vinyl laurate (15.0 g), nonionic surfactant IT8 (0.5 g), sodium dodecyl sulfate (0.5 g) and n-hexadecane (0.7 g) were added.

This mixture was first finely dispersed for 15 minutes with an Ultra-Turrax device at 6500 revolutions per minute and then treated with ultrasound, using an ultrasound probe, for 30 minutes at an amplitude of 95 μm. The resulting miniemulsion was transferred to a dropping funnel.

A 250 mL three-neck flask was charged with Aerosol MA 30 (0.5 mL), Brüggolit FF6 (110 mg), water (2 mL) and 4 mL of the miniemulsion.

The mixture was heated to 60° C.

The initiator phase, consisting of water (10 mL) and tert-butyl hydroperoxide (0.5 mL), was added dropwise at a rate of 0.1 mL/min.

The remaining miniemulsion was added over a period of 3 hours. This was followed by renewed addition of 0.5 mL of tert-butyl hydroperoxide and azobis(isobutyronitrile) (AIBN) (0.26 g) for the postpolymerization. The mixture was left at 60° C. for 45 minutes more.

At the end, a solids content of 10.54% was established. The pH of the emulsion was 8.0.

The particle size was 168 nm with a particle size distribution of PDI=0.110.

The incorporation ratio of 2-methoxy-4-methylene-1,3-dioxolane to vinyl laurate was 15.6 mol %, the theoretical expectation having been 39.4 mol %. The number-average molecular weight was 13.5 kg/mol with a PDI of 2.71.

A stable, colorless emulsion was obtained.

### EXAMPLE 4

### Bulk polymerization of 2-isopropyl-4-methylene-1,3-dioxolane with acrylic acid

Acrylic acid (1.0 g) with 2-isopropyl-4-methylene-1,3-dioxolane (1.0 g) and azobis(isobutyronitrile) (AIBN) (59 mg) were brought to polymerization at 70° C. After 3 h the reaction was discontinued.

The polymer was dissolved in methanol overnight and precipitated from water. This procedure was repeated once. The product isolated by centrifuging and dried under reduced pressure was a brown solid. 1H and 13C NMR spectroscopy confirmed the incorporation of both comonomers into the copolymer.

### EXAMPLE 5

### Bulk polymerization of vinyl acetate with 2-isopropyl-4-methylene-1,3-dioxolane (I4MDO)

Vinyl acetate (5.0 g) was brought to reaction with 2-isopropyl-4-methylene-1,3-dioxolane (I4MDO) (5.0 g) and azobis(isobutyronitrile) (AIBN) (40 mg) at 70° C. for 7 h in a glass vessel with screw lid. A yellowish oil/gel was obtained. It was dissolved in tetrahydrofuran and precipitated from a methanol-water mixture. The precipitate was subsequently dried to constant weight.

1H NMR spectroscopy verified the incorporation of 14MDO at 40.8 mol % (theoretical expectation: 40.2 mol %); the number-average molecular weight was 1.9 kg/mol with a PDI of 3.63.

### EXAMPLE 6

### Bulk polymerization of 2-methoxy-4-methylene-1,3-dioxolane (MOMDO) with acrylic acid, and self-degradation thereof in water

In a glass vessel with screw lid, azobis(isobutyronitrile) (AIBN) (40 mg), acrylic acid (1.0 g) and MOMDO (1.08 g) were heated for 3 min at 80° C. After three minutes, the entire mass had undergone complete polymerization. This polymer was dissolved in 1,3-dioxolane, precipitated from cyclohexane and dried using reduced pressure.

A number-average molecular weight was detected of 1611 kg/mol with a PDI of 2.53; the incorporation of both comonomers was confirmed by 1H and 13C NMR spectroscopy; the incorporation of MOMDO was 26.7 mol %, the theoretical expectation having been 41.9 mol %. 100 mg of this polymer was subsequently dissolved in 1.66 mL of deionized water for 15 hours. A pH of 3.0 was established. Subsequently, the polymer was again dried and analyzed via gel permeation chromatography. A number-average molecular weight of 174 kg/mol was detected, corresponding to a reversal/degradation of about 90%.

### EXAMPLE 7

### Aqueous emulsion polymerization of vinyl acetate with 2-isopropyl-4-methylene-1,3-dioxolane (I4MDO)

Sodium dodecyl sulfate (0.62 g), sodium hydrogencarbonate (0.3 g), ammonium peroxodisulfate (0.221 g) dissolved in water (2.0 mL) (added separately after heating to 60° C.), water (20.0 mL), 2-isopropyl-4-methylene-1,3-dioxolane (4.00 g) and vinyl acetate (16.0 g) were added to a 3-neck flask. The mixture was refluxed at 60° C. for 7 hours with stirring. A solids content of 28.76% was established. The particle size was 6180 nm with a particle size distribution of PDI=0.490. The incorporation ratio of 2-isopropyl-4-methylene-1,3-dioxolane to vinyl acetate was 14.2 mol %, the theoretical expectation having been 14.4 mol %.

The result was a creamy, milky emulsion.

### REFERENCE EXAMPLE 8

### Aqueous emulsion polymerization of 2-isopropyl-4-methylene-1,3-dioxolane (I4MDO)

Sodium dodecyl sulfate (0.30 g), sodium hydrogencarbonate (0.17 g), potassium peroxodisulfate (0.57 g), water (20.1 mL) and 2-isopropyl-4-methylene-1,3-dioxolane (6.00 g) were placed in a 50 mL flask. The mixture was refluxed at 70° C. for 4.5 hours with stirring. The result was a milky suspension.

20 μL of the sample were withdrawn, dissolved in dimethyl sulfoxide, and analyzed via gas chromatography for the amount of residual monomer (2-isopropyl-4-methylene-1,3-dioxolane). The latter was not detectable.

The particle size was 7200 nm with a particle size distribution of PDI=0.151.

### Testing of Polymer Biodegradability:

The biodegradability of the polymers was determined using aqueous dispersions according to DIN EN ISO 9439 (Water quality-Determination of ultimate aerobic biodegradability of organic compounds in aqueous medium-Carbon dioxide measurement method).

This method studies the percentage degradation of different polymer dispersion samples by the microorganisms contained in municipal wastewater.

The carbon content of the polymer dispersion can be determined by elemental analysis beforehand. From this it is possible to determine the quantity of carbon dioxide that would necessarily be formed in the event of complete aerobic degradation of the sample. Complete conversion of all of the carbon present in the sample into carbon dioxide corresponds here to a theoretical degradation of 100%.

Sodium benzoate is used as a reference sample having good biodegradability.

It should be noted that, generally, 100% degradation is not achieved, because the carbon present in the sample, as well as being converted to carbon dioxide by the microorganisms, is also used as a scaffold substance and is also broken down into other metabolic end products that are not detectable in this method.

The results of the testing are summarized in Table 1.

TABLE 1
Biological degradability results:

| | Degradation rate [%] | | | |
|---|---|---|---|---|
| | | I4MDO | | |
| | | homopolymer^{a)} | Copolymer | |
| | Vinyl acetate | from Reference | from | Sodium |
| Days | homopolymer | Example 8 | Example 7 | benzoate |
| 0 | 0 | 0 | 0 | 0 |
| 4 | not detectable | 50 | 19 | 65 |
| 8 | not detectable | 62 | 24 | 81 |
| 16 | not detectable | 65 | 26 | 86 |
| 28 | 3 | 68 | 32 | 88 |
| 56 | — | 67 | 44 | 91 |
| 72 | — | 68 | 49 | 90 |

^{a)}I4MDO: 2-Isopropyl-4-methylene-1,3-dioxolane

1-14. (canceled)

15. Biodegradable copolymers obtainable via radically initiated emulsion polymerization processes and containing
a) one or more monomer units of the formula I: 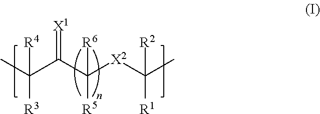
where n=1 to 3,
in which X¹ and X² independently of one another are the atoms O or S or the group N—R⁷
R¹ and R² independently of one another are hydrogen, an alkyl, alkenyl, alkoxy or aryl radical or a spirocyclic aliphatic group,
R³, R⁴, R⁵, R⁶ and R⁷ independently of one another are hydrogen or an alkyl or aryl radical, and
b) vinyl acetate units and optionally one or more monomer units selected from the group encompassing vinyl ester units of alpha-branched monocarboxylic acids having 5 to 13 carbon atoms, vinyl propionate, vinyl butyrate, vinyl 2-ethylhexanoate, vinyl laurate, 1-methylvinyl acetate, vinyl pivalate, (meth)acrylic ester, vinylaromatic, olefin, 1,3-diene and vinyl halide units.

16. The biodegradable copolymers as claimed in claim 15, wherein the monomer units a) of the formula I, n is 1.

17. The biodegradable copolymers as claimed in claim 15, wherein the monomer units a) of the formula I, X¹ and/or X² are an oxygen atom.

18. The biodegradable copolymers as claimed in claim 15, wherein the monomer units a) of the formula I, one or more radicals R¹ and R² are selected from the group encompassing ethyl, propyl, butyl, methyl, isopropyl, phenyl, ethoxy, butoxy and methoxy radicals.

19. The biodegradable copolymers as claimed in claim 15, wherein the monomer units a) of the formula I, one of the radicals R¹ and R² is other than hydrogen.

20. The biodegradable copolymers as claimed in claim 15, wherein the fraction of the monomer units a) of the formula I is 1% to 99% by weight, based on the total weight of the biodegradable copolymers.

21. The biodegradable copolymers as claimed in claim 15, wherein the fraction of the monomer units b) is 1% to 99% by weight, based on the total weight of the biodegradable copolymers.

22. The biodegradable copolymers as claimed in claim 15, wherein one or more monomer units b) are selected from the group encompassing methyl acrylate, methyl methacrylate, ethyl acrylate, ethyl methacrylate, propyl acrylate, propyl methacrylate, n-butyl acrylate, n-butyl methacrylate, 2-ethylhexyl acrylate, norbornyl acrylate, vinyl propionate, vinyl butyrate, vinyl 2-ethylhexanoate, vinyl laurate, 1-methylvinyl acetate and vinyl pivalate units and units of vinyl esters of alpha-branched monocarboxylic acids having 5 to 13 carbon atoms.

23. The biodegradable copolymers as claimed in claim 15, wherein the aqueous dispersions of the biodegradable copolymers have a viscosity of 1 to 5000 mPas (determined at 25.0° C., at a solids content of 25%).

24. The biodegradable copolymers as claimed in claim 15, wherein the biodegradable copolymers are present in the form of aqueous dispersions or in the form of water-redispersible powders.

25. A process for preparing biodegradable copolymers by radically initiated emulsion polymerization of
a) one or more monomers of the formula II: 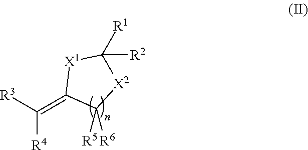
where n=1 to 3,
in which X¹ and X² independently of one another are the atoms O, N—R⁷ or S,
R¹ and R² independently of one another are hydrogen, an alkyl, alkenyl, alkoxy or aryl radical or a spirocyclic aliphatic group,
R³, R⁴, R⁵, R⁶ and R⁷ independently of one another are hydrogen or an alkyl or aryl radical, and
b) vinyl acetate and optionally one or more further ethylenically unsaturated monomers selected from the group encompassing vinyl propionate, vinyl butyrate, vinyl 2-ethylhexanoate, vinyl laurate, 1-methylvinyl acetate, vinyl pivalate, vinyl esters of alpha-branched monocarboxylic acids having 5 to 13 carbon atoms, (meth)acrylic esters, vinylaromatics, olefins, 1,3-dienes and vinyl halide.

26. The use of the biodegradable copolymers of claim 15 as a binder for coating materials or adhesive bonding materials, more particularly for paints, inks, textiles, paper or carpets.

27. The use of the biodegradable copolymers of claim 15 in leveling compounds, construction adhesives, tile adhesives, exterior wall insulation adhesives, renders, filling compounds, jointing mortars, grouts, paints or inks.
